(19) United States
(12) Patent Application Publication
(10) Pub. No.: US 2022/0122557 A1
(43) Pub. Date: Apr. 21, 2022

(54) DISPLAY DEVICE AND DRIVING METHOD THEREOF

(71) Applicant: SHENZHEN CHINA STAR OPTOELECTRONICS SEMICONDUCTOR DISPLAY TECHNOLOGY CO., LTD., Shenzhen (CN)

(72) Inventors: Seongil KIM, Shenzhen (CN); Hongbin JANG, Shenzhen (CN); Ilgon KIM, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 16/766,707

(22) PCT Filed: May 12, 2020
(86) PCT No.: PCT/CN2020/089823

§ 371 Date: May 25, 2020

(30) Foreign Application Priority Data
Mar. 30, 2020 (CN) 202010234050.1

(51) Int. Cl. G09G 3/36

(52) U.S. Cl. CPC G09G 3/3614; G09G 3/3677; G09G 3/3607; G09G 2310/08; G09G 3/3688

(57) ABSTRACT

The present application provides a display device and a driving method thereof. In a previous ½ frame, scan signals are input to scan lines in a first scan line group, and data signals having a first polarity are input to same data lines. In a subsequent ½ frame, the scan signals are input to the scan lines in a second scan line group, and data signals having a second polarity are input to the data lines transmitting the data signals having the first polarity in the previous ½ frame. A specific composition of the first scan line group and the second scan line group prevents vertical lines and diagonal lines from occurring during display.

### FIELD OF APPLICATION

The present application is related to the field of display technology, and specifically, to a display device and a driving method thereof.

### BACKGROUND OF APPLICATION

Currently, with resolutions of display devices gradually increasing, the resolutions of the display devices have reached 8K (7680×4320). For a display device having a 1G1D structure, operation of a source driver is accompanied by problems of temperature increase and large power consumption. As shown in FIGS. 3 and 4, FIG. 3 is a schematic diagram of a vertical line occurring in a traditional 1G1D structure display device which adopts column inversion drive, and FIG. 4 is a schematic diagram of a diagonal line occurring in a traditional flip-pixel structure display device which adopts the column inversion drive. It can be seen in FIG. 3 that subpixels in a same column have a same polarity when the 1G1D structure display device adopts the column inversion drive, and the occurrence of the vertical line is caused by the subpixels in the same column all having positive polarity during display. It can be seen in FIG. 4 that polarities of subpixels in a same diagonal line are all positive or negative when the flip-pixel structure display device adopts the column inversion drive, and the occurrence of the diagonal line is caused by the subpixels in the same diagonal line all having positive polarity during display.

Therefore, it is necessary to solve the problems of high temperature and large power consumption in the traditional technology display device and the problems of the vertical line or the diagonal line caused by the traditional column inversion drive.

### SUMMARY OF APPLICATION

A purpose of the present application is to provide a display device and a driving method thereof, so as to solve problems of high temperature and large power consumption in a traditional technology display device, which prevents a 1G1D structure display device from occurring a vertical line or a diagonal line during display.

In order to achieve the above purpose, the present application provides the driving method of the display device. The display device includes a plurality of scan lines for transmitting scan signals, a plurality of data lines for transmitting data signals, a gate driving unit, a source driving unit, and a plurality of subpixels arranged in an array. The plurality of subpixels in each row are connected to a same one of the scan lines. The plurality of subpixels in each column are connected to a same one of the data lines. The plurality of scan lines include a first scan line group and a second scan line group. Each of the first scan line group and the second scan line group includes at least two of the scan lines. The driving method includes the steps of:

in a previous ½ frame, the gate driving unit inputting the scan signals to the plurality of scan lines in the first scan line group, and the source driving unit inputting the data signals having a first polarity to the plurality of data lines; and

in a subsequent ½ frame, the gate driving unit inputting the scan signals to the plurality of scan lines in the second scan line group, and the source driving unit inputting the data signals having a second polarity to the plurality of data lines transmitting the data signals having the first polarity in the previous ½ frame.

The first polarity is opposite to the second polarity. In the previous ½ frame and the subsequent ½ frame, polarities of the data signals input from adjacent two of the data lines are opposite. Two adjacent subpixels in four adjacent subpixels in a same row are input the data signals corresponding to high gray levels, and another two adjacent subpixels are input the data signals corresponding to low gray levels. Gray level values corresponding to the high gray levels are greater than gray level values corresponding to the low gray levels.

The first scan line group includes a (4n−3)th scan line and a (4n−2)th scan line, and the second scan line group includes a (4n−1)th scan line and a 4nth scan line, where n is an integer greater than or equal to 1 and less than or equal to m, m is an integer greater than or equal to 1, and a sum of a total number of the scan lines of the first scan line group and the second scan line group is 4m; or

the first scan line group includes a (12n−11)th scan line, a (12n−8)th scan line, a (12n−7)th scan line, a (12n−4)th scan line, a (12n−3)th scan line, and a 12nth scan line, and the second scan line group includes a (12n−10)th scan line, a (12n−9)th scan line, a (12n−6)th scan line, a (12n−5)th scan line, a (12n−2)th scan line, and a (12n−1)th scan line, where n is an integer greater than or equal to 1 and less than or equal to m, m is an integer greater than or equal to 1, and a sum of a total number of the scan lines of the first scan line group and the second scan line group is 12m.

In the above driving method of the display device, the driving method further includes the step of: in the previous ½ frame and the subsequent ½ frame, respectively inputting the data signals corresponding to the high gray levels and the data signals corresponding to the low gray levels to two adjacent subpixels in a same column.

In the above driving method of the display device, the plurality of subpixels in each row include red subpixels, green subpixels, and blue subpixels, which are sequentially and repeatedly disposed. The plurality of subpixels in each column include one of the red subpixels, the green subpixels, or the blue subpixels.

In the above driving method of the display device, a vertical blank period is provided between the previous ½ frame and the subsequent ½ frame.

In the above driving method of the display device, the display device further includes a timing controller. The driving method further includes the steps of:

the timing controller outputting clock signals to the gate driving unit;

the gate driving unit outputting the scan signals to the first scan line group in the previous ½ frame according to the clock signals and outputting the scan signals to the second scan line group in the subsequent ½ frame;

the timing controller outputting polarity inversion control signals to the source driving unit; and

the source driving unit inverting the data signals having the first polarity to the data signals having the second polarity between the previous ½ frame and the subsequent ½ frame according to the polarity inversion control signals.

In the above driving method of the display device, the first polarity is positive, and the second polarity is negative.

A display device, including a plurality of scan lines, a plurality of data lines, a gate driving unit, a source driving unit, and a plurality of subpixels arranged in an array. The plurality of subpixels in each row are connected to a same one of the scan lines, and the plurality of subpixels in each column are connected to a same one of the data lines. The plurality of scan lines include a first scan line group and a second scan line group. Each of the first scan line group and the second scan line group includes at least two of the scan lines.

The gate driving unit is used to input scan signals to the plurality of scan lines in the first scan line group in a previous ½ frame and input the scan signals to the plurality of scan lines in the second scan line group in a subsequent ½ frame.

The source driving unit is used to input data signals having a first polarity to the plurality of data lines in the previous ½ frame and input data signals having a second polarity to the plurality of data lines transmitting the data signals having the first polarity in the previous ½ frame in the subsequent ½ frame. The first polarity is opposite to the second polarity.

In the previous ½ frame and the subsequent ½ frame, two adjacent data lines are used to respectively input the data signals having opposite polarities.

In the previous ½ frame and the subsequent ½ frame, two adjacent subpixels in four adjacent subpixels in a same row are used to input the data signals corresponding to high gray levels, and another two adjacent subpixels are used to input the data signals corresponding to low gray levels. Gray level values corresponding to the high gray levels are greater than gray level values corresponding to the low gray levels.

The first scan line group includes a (4n−3)th scan line and a (4n−2)th scan line, and the second scan line group includes a (4n−1)th scan line and a 4nth scan line, where n is an integer greater than or equal to 1 and less than or equal to m, m is an integer greater than or equal to 1, and a sum of a total number of the scan lines of the first scan line group and the second scan line group is 4m; or

the first scan line group includes a (12n−11)th scan line, a (12n−8)th scan line, a (12n−7)th scan line, a (12n−4)th scan line, a (12n−3)th scan line, and a 12nth scan line, and the second scan line group includes a (12n−10)th scan line, a (12n−9)th scan line, a (12n−6)th scan line, a (12n−5)th scan line, a (12n−2)th scan line, and a (12n−1)th scan line, where n is an integer greater than or equal to 1 and less than or equal to m, m is an integer greater than or equal to 1, and a sum of a total number of the scan lines of the first scan line group and the second scan line group is 12m.

In the above display device, in the previous ½ frame and the subsequent ½ frame, two adjacent subpixels in a same column are used to respectively input the data signals corresponding to the high gray levels and the data signals corresponding to the low gray levels.

In the above display device, the plurality of subpixels in each row include red subpixels, green subpixels, and blue subpixels, which are sequentially and repeatedly disposed. The plurality of subpixels in each column include one of the red subpixels, the green subpixels, or the blue subpixels.

In the above display device, the display device further includes a timing controller.

The timing controller is used to output clock signals to the gate driving unit and output polarity inversion control signals to the source driving unit.

The gate driving unit is used to output the scan signals to the first scan line group in the previous ½ frame according to the clock signals and output the scan signals to the second scan line group in the subsequent ½ frame.

The source driving unit is used to invert the data signals having the first polarity to the data signals having the second polarity between the previous ½ frame and the subsequent ½ frame according to the polarity inversion control signals.

In the above display device, the first polarity is positive, and the second polarity is negative.

The present application provides the display device and the driving method thereof. The display device includes the plurality of scan lines for transmitting the scan signals, the plurality of data lines for transmitting the data signals, the gate driving unit, the source driving unit, and the plurality of subpixels arranged in the array. The plurality of subpixels in each row are connected to the same one of the scan lines, and the plurality of subpixels in each column are connected to the same one of the data lines. The plurality of scan lines include the first scan line group and the second scan line group. Each of the first scan line group and the second scan line group includes at least two of the scan lines. The driving method includes the steps of: in a previous ½ frame, the gate driving unit inputting the scan signals to the plurality of scan lines in the first scan line group, and the source driving unit inputting the data signals having a first polarity to the plurality of data lines; and in a subsequent ½ frame, the gate driving unit inputting the scan signals to the plurality of scan lines in the second scan line group, and the source driving unit inputting the data signals having a second polarity to the plurality of data lines transmitting the data signals having the first polarity in the previous ½ frame. The first polarity is opposite to the second polarity. In the previous ½ frame and the subsequent ½ frame, polarities of the data signals input from adjacent two of the data lines are opposite. Two adjacent subpixels in four adjacent subpixels in a same row are input the data signals corresponding to high gray levels, another two adjacent subpixels are input the data signals corresponding to low gray levels. Gray level values corresponding to the high gray levels are greater than gray level values corresponding to the low gray levels. The first scan line group includes a (4n−3)th scan line and a (4n−2)th scan line, and the second scan line group includes a (4n−1)th scan line and a 4nth scan line, where n is an integer greater than or equal to 1 and less than or equal to m, m is an integer greater than or equal to 1, and a sum of a total number of the scan lines of the first scan line group and the second scan line group is 4m; or the first scan line group includes a (12n−11)th scan line, a (12n−8)th scan line, a (12n−7)th scan line, a (12n−4)th scan line, a (12n−3)th scan line, and a 12nth scan line, and the second scan line group includes a (12n−10)th scan line, a (12n−9)th scan line, a (12n−6)th scan line, a (12n−5)th scan line, a (12n−2)th scan line, and a (12n−1)th scan line, where n is an integer greater than or equal to 1 and less than or equal to m, m is an integer greater than or equal to 1, and a sum of a total number of the scan lines of the first scan line group and the second scan line group is 12m. Through dividing the plurality of scan lines into two groups, the plurality of scan lines in each group perform a scan in a ½ scan period, the polarity of the data signals in each ½ frame does not change, and the polarity of the data signals change once in a frame. Therefore, the source driving unit is prevented from an increase of power consumption and high temperature caused by high frequency polarity inversion of the data signals. Also, through a specific composition of the first scan line group and the second scan line group of the present application accompanied by opposite polarities of the data signals input from the adjacent two of the data lines, positive-polarity subpixels and negative-polarity subpixels are evenly dispersed, which prevents the positive-polarity subpixels and the negative-polarity subpixels from gathering on a same straight line, thereby preventing a phenomenon of vertical lines or diagonal lines from occurring during display. In addition, two adjacent subpixels in four adjacent subpixels in the same row are input the data signals corresponding to the high gray levels, and another two adjacent subpixels are input the data signals corresponding to the low gray levels. This makes the high gray level positive-polarity subpixels and the high gray level negative-polarity subpixels be adjacent to each other in a same row, and makes the low gray level positive-polarity subpixels and the low gray level negative-polarity subpixels be adjacent to each other. A voltage change of high gray level subpixels offsets a voltage change of low gray level subpixels caused by a coupling effect between pixel electrodes and adjacent data lines not connected to the pixel electrodes, which prevents a problem of horizontal crosstalk.

### DESCRIPTION OF DRAWINGS

FIG. 1 is a schematic diagram of a display device of an embodiment of the present application.

FIG. 2 is a schematic diagram of a liquid crystal display panel shown in FIG. 1.

FIG. 3 is a schematic diagram of a vertical line occurring in a traditional 1G1D structure display device which adopts a column inversion drive.

FIG. 4 is a schematic diagram of a diagonal line occurring in a traditional flip-pixel structure display device which adopts the column inversion drive.

FIG. 5 is a timing diagram of 2-line inversion in traditional technology.

FIG. 6 is a flowchart of a driving method of the display device of an embodiment of the present application.

FIG. 7 is a schematic diagram of connections between clock signal lines CK1-CK12 and gate driving units in the display device of an embodiment of the present application.

FIG. 8A is a timing diagram of a driving method of a display device of a comparative embodiment.

FIG. 8B is a schematic diagram of polarity distribution of corresponding subpixels driven by the timing diagram shown in FIG. 8A.

FIG. 9A is a first timing diagram of the driving method of an embodiment of the present application.

FIG. 9B is a schematic diagram of polarity distribution of corresponding subpixels driven by the display device of an embodiment of the present application using the first timing diagram shown in FIG. 9A.

FIG. 10A is a second timing diagram of the driving method of an embodiment of the present application.

FIG. 10B is a schematic diagram of polarity distribution of corresponding subpixels driven by the display device of an embodiment of the present application using the first timing diagram shown in FIG. 10A.

### DETAILED DESCRIPTION OF PREFERRED EMBODIMENTS

To further explain the technical means and effect of the present application, the following refers to embodiments and drawings for detailed description. Obviously, the described embodiments are only for some embodiments of the present application, instead of all embodiments. All other embodiments based on embodiments in the present application and obtained by those skilled in the art without creative efforts are within the scope of the present application.

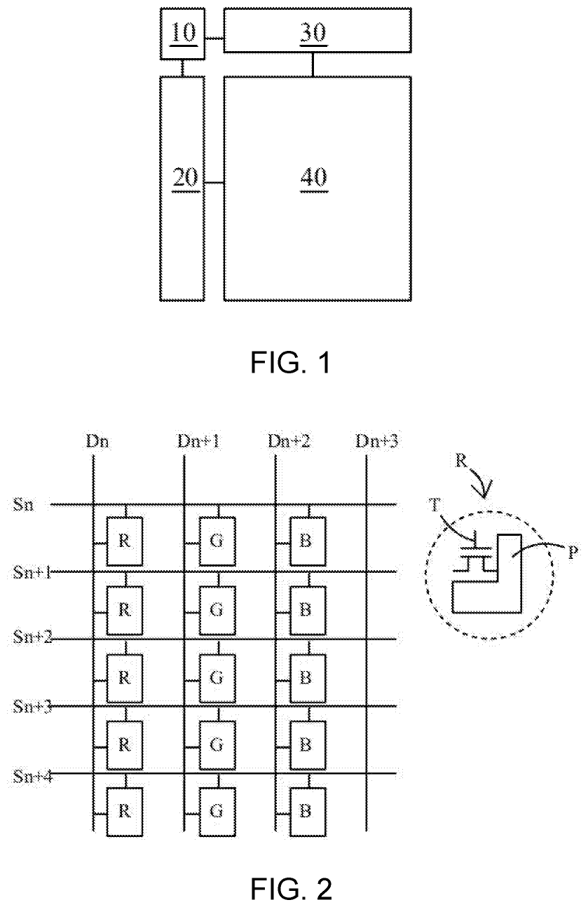

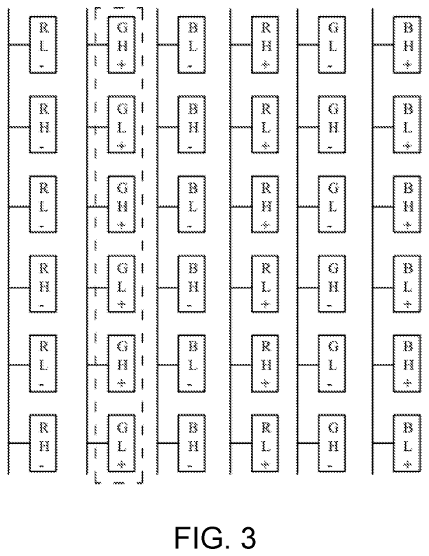

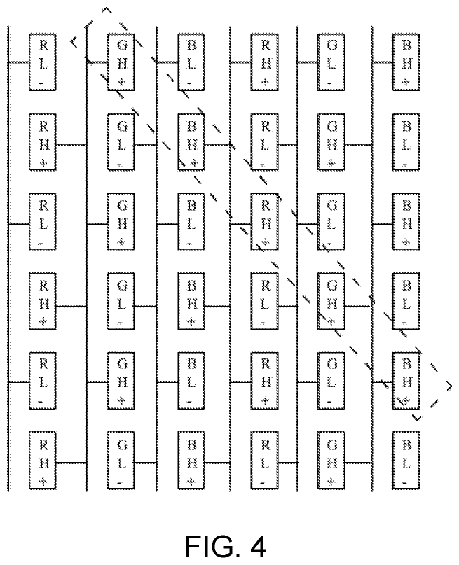

Please refer to FIG. 1, it is a schematic diagram of a display device of an embodiment of the present application. The display device is a liquid crystal display. The display device includes a timing controller 10, a gate driving unit 20, a source driving unit 30, and a liquid crystal display panel 40. The timing controller 10 is electrically connected to the gate driving unit 20 and the source driving unit 30. The source driving unit 30 and the gate driving unit 20 are connected to the liquid crystal display panel 40.

Please refer to FIG. 2, it is a schematic diagram of the liquid crystal display panel shown in FIG. 1. The liquid crystal display panel includes a plurality of scan lines S (e.g., Sn, Sn+1, etc.) for transmitting scan signals, a plurality of data lines D (e.g., Dn, Dn+1, etc.) for transmitting data signals, and a plurality of subpixels arranged in an array. The plurality of scan lines S are disposed in parallel and arranged in a column direction. The plurality of data lines D are disposed in parallel and arranged in a row direction. The plurality of scan lines S and the plurality of data lines D are insulated and cross each other. Two adjacent data lines D and two adjacent scan lines S define a region of a subpixel region. One subpixel region is disposed with one subpixel. Each subpixel includes a thin-film transistor T and a pixel electrode P. A gate of the thin-film transistor T is connected to the scan line S. A source of the thin-film transistor T is connected to the data line D. A drain of the thin-film transistor T is connected to the pixel electrode P. The plurality of subpixels in each row are connected to a same scan line. The plurality of subpixels in each column are connected to a same data line. The plurality of subpixels in each row emit a same color light. The plurality of subpixels in each row include red subpixels, green subpixels, and blue subpixels, which are sequentially and repeatedly disposed, that is, a red subpixel, a green subpixel, and a blue subpixel constitute a repeating unit and are repeatedly arranged in a row. The plurality of subpixels in each column include one of the red subpixels, the green subpixels, or the blue subpixels. Thus, the liquid crystal display panel of the present application adopts a 1G1D normal pixel structure.

The plurality of scan lines S include a first scan line group and a second scan line group. Each of the first scan line group and the second scan line group includes at least two scan lines. A number of the plurality of scan lines constituting the first scan line group is same as a number of the plurality of scan lines constituting the second scan line group. Numbers of the plurality of subpixels connected to every scan line are same. A time required to scan each scan line in the first scan line group is equal to a time required to scan each scan line in the second scan line group, so a total time required to scan all the scan lines in the first scan line group is equal to a time required to scan all the scan lines in the second scan line group.

In a period of one frame, the gate driving unit 20 is used to input the scan signals to the plurality of scan lines S in the first scan line group in a previous ½ frame to sequentially turn on the subpixels connected to the plurality of scan lines S in the first scan line group, and input the scan signals to the plurality of scan lines S in the second scan line group in a subsequent ½ frame to sequentially turn on the subpixels connected to the plurality of scan lines S in the second scan line group.

The source driving unit 30 is used to input the data signals having a first polarity to the plurality of data lines D in the previous ½ frame and input the data signals having a second polarity to the plurality of data lines D transmitting the data signals having the first polarity in the previous ½ frame in the subsequent ½ frame. The first polarity is opposite to the second polarity.

The timing controller 10 is used to output control signals such as row initial pulse signals and clock signals to the gate driving unit 20. Also, the timing controller 10 is used to output control signal such as polarity inversion control signals POL to the source driving unit 30.

The gate driving unit 20 outputs the scan signals to the first scan line group in the previous ½ frame according to the clock signals and outputs the scan signals to the second scan line group in the subsequent ½ frame. The source driving unit 30 converts display data signals into the data signals (analog driving voltage). The source driving unit 30 inputs the data signals to the liquid crystal display panel 40 to charge the subpixels on the liquid crystal display panel 40. The source driving unit 30 inverts the data signals having the first polarity to the data signals having the second polarity between the previous ½ frame and the subsequent ½ frame according to the polarity inversion control signals.

In this embodiment, the first polarity is positive, and the second polarity is negative.

In the previous ½ frame, the gate driving unit 20 sequentially inputs the scan signals to each scan line S in the first scan line group. After gates of the subpixels connected to any row of the scan line S in the first scan line group are turned on, the source driving unit 30 inputs the data signals having the first polarity to the data lines S, so that sources of the subpixels turned on by the gates are written with the data signals having the first polarity, which then are transmitted to corresponding pixel electrodes to charge the pixel electrodes. In the previous ½ frame, a polarity of the data signals output from the source driving unit 30 to a same data line is always the first polarity without inversion, and polarities of the data signals input to adjacent two data lines D are opposite. After the subpixels on the scan lines S in the first scan line group are charged, the source driving unit 30 inverts the data signals having the first polarity to the data signals having the second polarity, and the first polarity is opposite to the second polarity. In the subsequent ½ frame, the gate driving unit 20 sequentially inputs the scan signals to each scan line S in the second scan line group. After gates of the subpixels connected to any row of the scan line S in the second scan line group are turned on, the source driving unit 30 inputs the data signals having the second polarity to the data lines D transmitting the data signals having the first polarity in the previous ½ frame, so that sources of the subpixels on any row of the scan line S in the second scan line group turned on by the gates are written with the data signals having the second polarity, which then are transmitted to corresponding pixel electrodes to charge the pixel electrodes. In the subsequent ½ frame, a polarity of the data signals output from the source driving unit 30 to a same data line is always the second polarity without inversion. Therefore, in one frame, the polarity of the data signals transmitted in the same data line only needs to be inverted once, which reduces a frequency of polarity inversion of the source driving unit 30, reduces power consumption of the source driving unit 30, and prevents the source driving unit 30 from generating heat and heating up.

The first scan line group includes a (4n−3)th scan line and a (4n−2)th scan line, the second scan line group includes a (4n−1)th scan line and a 4nth scan line, where n is an integer greater than or equal to 1 and less than or equal to m, m is an integer greater than or equal to 1, and a sum of a total number of the scan lines of the first scan line group and the second scan line group is 4m. Regardless of whether the polarities of the data signals input to two adjacent subpixels connected to a same scan line are same or different, a 2-line inversion effect of one frame in traditional technology can be achieved. Compared with the 2-line inversion driving method in traditional technology, the power consumption of the source driving unit 30 of the 1G1D structure display device can be reduced, and the source driving unit 30 can be prevented from generating heat and heating up, which can solve problems of heating of the source driving unit 30 and an increase of power consumption in viewing angle compensation achieved by the 2-line inversion in traditional technology. Also, when the polarities of the data signals input from combining two adjacent data lines D are opposite, it is possible to prevent vertical lines and diagonal lines from occurring in the 1G1D structure display device with a traditional column inversion drive. The traditional 2-line inversion refers to the positive half and negative half of the data lines, and the polarity of the data signals is converted every two scan lines.

The first scan line group includes a (12n−11)th scan line, a (12n−8)th scan line, a (12n−7)th scan line, a (12n−4)th scan line, a (12n−3)th scan line, and a 12nth scan line, and the second scan line group includes a (12n−10)th scan line, a (12n−9)th scan line, a (12n−6)th scan line, a (12n−5)th scan line, a (12n−2)th scan line, and a (12n−1)th scan line, where n is an integer greater than or equal to 1 and less than or equal to m, m is an integer greater than or equal to 1, and a sum of a total number of the scan lines of the first scan line group and the second scan line group is 12m. Regardless of whether the polarities of the data signals input to two adjacent subpixels connected to a same scan line are same or different, a 1+2-line inversion of one frame can be achieved. Compared with the 1+2-line inversion in traditional technology, the power consumption of the source driving unit can be reduced, and the source driving unit can be prevented from generating heat and heating up. Also, when the polarities of the data signals input from combining two adjacent data lines D are opposite, it is possible to prevent vertical lines and diagonal lines from occurring in the 1G1D structure display device with a traditional column inversion drive. The traditional 1+2-line inversion refers to the positive half and negative half of the data lines, and the polarity of the data signals is converted every one scan line or every two scan lines.

However, because the pixel electrode P of the subpixel and the data line D adjacent to the pixel electrode P and not electrically connected thereto form a parasitic capacitance Cpd, two adjacent subpixels in a same row adopt high and low gray levels. When polarities of the high gray level subpixels and the low gray level subpixels in a same row are same, voltage differences of the high gray level subpixels and the low gray level subpixels generated by a capacitive coupling effect are different and cannot offset each other, which causes a problem of horizontal crosstalk. Specifically, the voltage difference V of the subpixels generated by the capacitive coupling effect between the pixel electrode and the data line equals to |Vdata−Vcom|×Cpd/Ctotal, where Vdata is a data voltage input from the data line adjacent to the pixel electrode P and not electrically connected thereto, Vcom is a voltage of a common electrode, and Ctotal is a sum of the parasitic capacitances formed between the pixel electrode and the scan line, and between the data line and the pixel electrode. When Cpd/Ctotal is constant, the voltage difference of the high gray level subpixel (the voltage difference of the high gray level subpixels corresponds to the data voltage of the low gray level subpixel) is less than the voltage difference of the low gray level subpixel (the voltage difference of the low gray level subpixels corresponds to the data voltage of the high gray level subpixel).

In order to solve the problem of the horizontal crosstalk when two adjacent subpixels in the same row adopt high and low gray levels, and the polarities of the high gray level subpixels and the low gray level subpixels in the same row are same, two adjacent subpixels in four adjacent subpixels in the same row are input the data signals corresponding to high gray levels, and another two adjacent subpixels are input the data signals corresponding to low gray levels. The polarities of the data signals input from two adjacent data lines are opposite. This makes the high gray level positive-polarity subpixels and the high gray level negative-polarity subpixels be adjacent to each other in the same row, and makes the low gray level positive-polarity subpixels and the low gray level negative-polarity subpixels be adjacent to each other. The voltage differences of the high gray level subpixels and the low gray level subpixels generated by the capacitive coupling effect offset each other, which prevents a problem of horizontal crosstalk.

Gray level values corresponding to the high gray levels are greater than gray level values corresponding to the low gray levels. For example, when the display device can display gray level values of 0-255, the gray level values of the high gray levels can be 255 or 235, and the gray level values of the low gray levels can be 0 or 20.

In the previous ½ frame and the subsequent ½ frame, two adjacent subpixels in a same column are used to respectively input the data signals corresponding to the high gray levels and the data signals corresponding to the low gray levels.

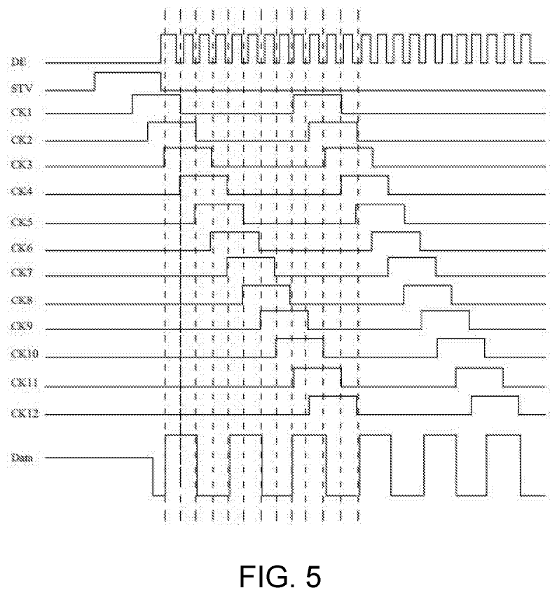

As shown in FIG. 5, it is a timing diagram of the 2-line inversion in traditional technology. During the 2-line inversion, the polarity of the data lines output from the source driving unit is inverted every two scan lines. If an inversion frequency is too large, it is accompanied by a negative effect of temperature increase of the source driving unit (D-IC), a decrease of a charging rate, and an increase of the power consumption.

In this embodiment, the timing controller is used to output clock signals to the gate driving unit and output polarity inversion control signals to the source driving unit.

The gate driving unit is used to output the scan signals to the first scan line group in the previous ½ frame according to the clock signals and output the scan signals to the second scan line group in the subsequent ½ frame.

The source driving unit is used to invert the data signals having the first polarity to the data signals having the second polarity between the previous ½ frame and the subsequent ½ frame according to the polarity inversion control signals. The first polarity is opposite to the second polarity.

In the previous ½ frame and the subsequent ½ frame, two adjacent data lines are used to respectively input the data signals having opposite polarities.

In the previous ½ frame and the subsequent ½ frame, two adjacent subpixels in four adjacent subpixels in the same row are used to input the data signals corresponding to the high gray levels, and another two adjacent subpixels are used to input the data signals corresponding to the low gray levels. The gray level values corresponding to the high gray levels are greater than gray level values corresponding to the low gray levels.

In this embodiment, in the previous ½ frame and the subsequent ½ frame, two adjacent subpixels in the same column are used to respectively input the data signals corresponding to the high gray levels and the data signals corresponding to the low gray levels.

In this embodiment, in one frame, a vertical blank period is provided between the previous ½ frame and the subsequent ½ frame.

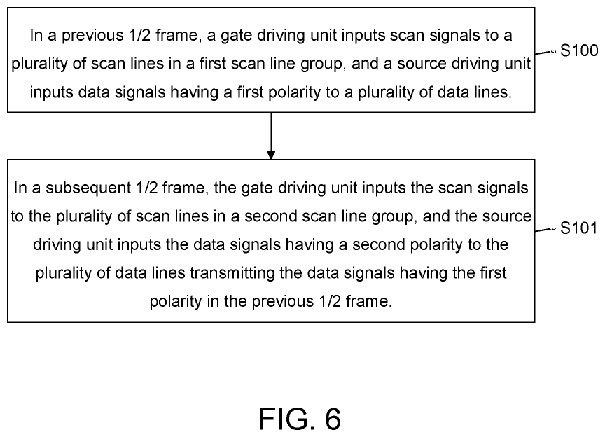

The present application further provides a driving method of the display device. The display device includes the plurality of scan lines for transmitting the scan signals, the plurality of data lines for transmitting the data signals, the gate driving unit, the source driving unit, and the plurality of subpixels arranged in the array. The plurality of subpixels in each row are connected to the same one of the scan lines. The plurality of subpixels in each column are connected to the same one of the data lines. The plurality of scan lines include the first scan line group and the second scan line group. Each of the first scan line group and the second scan line group includes at least two of the scan lines. As shown in FIG. 6, it is a flowchart of the driving method of the display device of an embodiment of the present application. The driving method includes the steps of:

S100: in the previous ½ frame, the gate driving unit inputting the scan signals to the plurality of scan lines in the first scan line group, and the source driving unit inputting the data signals having the first polarity to the plurality of data lines; and

S101: in the subsequent ½ frame, the gate driving unit inputting the scan signals to the plurality of scan lines in the second scan line group, and the source driving unit inputting the data signals having the second polarity to the plurality of data lines transmitting the data signals having the first polarity in the previous ½ frame.

The first polarity is opposite to the second polarity. In the previous ½ frame and the subsequent ½ frame, polarities of the data signals input from adjacent two of the data lines are opposite. Two adjacent subpixels in four adjacent subpixels in a same row are input the data signals corresponding to the high gray levels, another two adjacent subpixels are input the data signals corresponding to the low gray levels, and the gray level values corresponding to the high gray levels are greater than the gray level values corresponding to the low gray levels.

The first scan line group includes a (4n−3)th scan line and a (4n−2)th scan line, and the second scan line group includes a (4n−1)th scan line and a 4nth scan line, where n is an integer greater than or equal to 1 and less than or equal to m, m is an integer greater than or equal to 1, and a sum of a total number of the scan lines of the first scan line group and the second scan line group is 4m; or

the first scan line group includes a (12n−11)th scan line, a (12n−8)th scan line, a (12n−7)th scan line, a (12n−4)th scan line, a (12n−3)th scan line, and a 12nth scan line, and the second scan line group includes a (12n−10)th scan line, a (12n−9)th scan line, a (12n−6)th scan line, a (12n−5)th scan line, a (12n−2)th scan line, and a (12n−1)th scan line, where n is an integer greater than or equal to 1 and less than or equal to m, m is an integer greater than or equal to 1, and a sum of a total number of the scan lines of the first scan line group and the second scan line group is 12m.

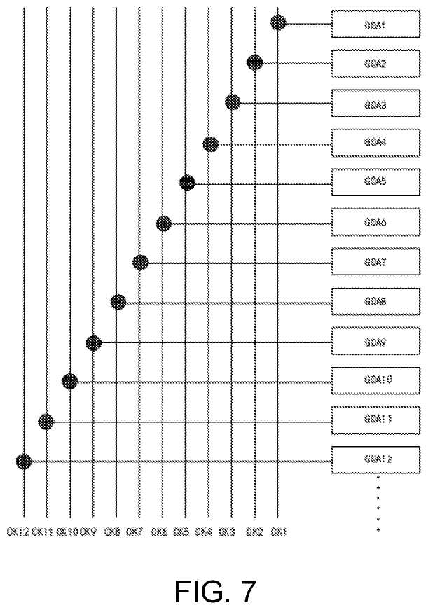

The above driving method is described in detail in conjunction with specific embodiments and comparative embodiment. In a first embodiment, a second embodiment, and the comparative embodiment, there are 12 clock signal lines, CK1-CK12. As shown in FIG. 7, it is a schematic diagram of connections between the clock signal lines CK1-CK12 and the gate driving units in the display device of an embodiment of the present application. CK1 is connected to a first gate driving unit GOA1, CK2 is connected to a second gate driving unit GOA2, CK3 is connected to a third gate driving unit GOA3, and CK4 is connected to a fourth gate driving unit GOA4, and so on. The scan lines are driven at 120 Hz, and the data lines are driven at 60 Hz. After saving one frame data in a frame memory of the timing controller, the timing controller controls the source driving unit to output the data signals according to an output order of the scan signals.

### Comparative Embodiment

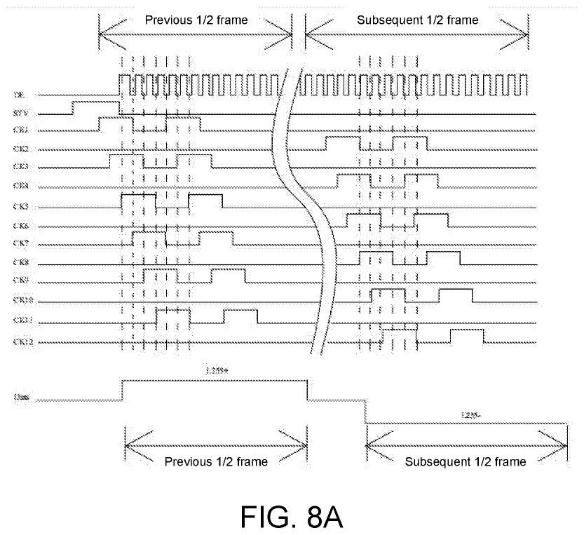

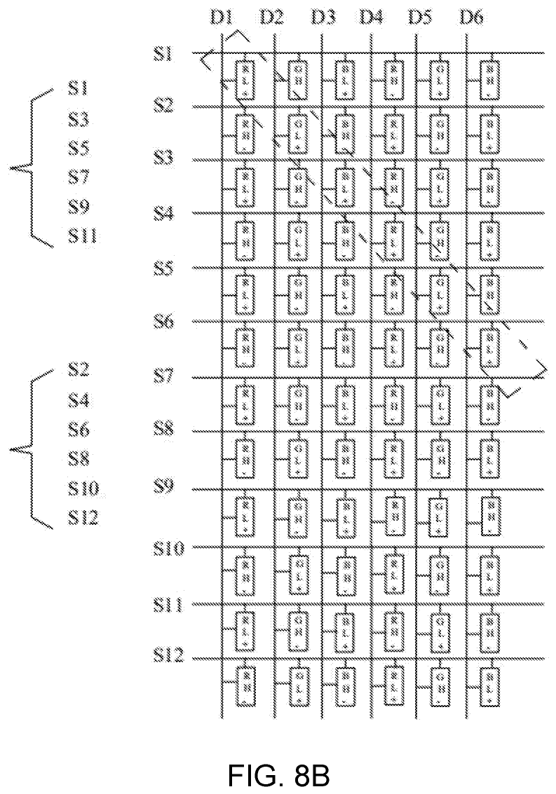

As shown in FIG. 8A, it is a timing diagram of the driving method of the display device of the comparative embodiment. In the comparative embodiment, a structure of the display device is shown as FIGS. 2 and 7, the driving method is basically similar to an embodiment of the present application. Differences are that the first scan line group includes odd scan lines such as scan lines S1, S3, S5, S7, S9, and S11, and the second scan line group includes even scan lines such as scan lines S2, S4, S6, S8, S10, and S12. In the previous ½ frame, the clock lines CK1, CK3, CK5, CK7, CK9, and CK11 sequentially output the clock signals to sequentially output the scan signals G1, G3, G5, G7, G9, and G11. After the scan signal G1 turns on a row of the subpixels, the data signals having the first polarity is input to the data lines, and polarities of the data signals input to the adjacent two data lines D are opposite, so as to charge the row of the subpixels. The row of the subpixels is turned off after charging is completed, and other scan signals are similar, which is not described in detail herein. After the previous ½ frame, in the vertical blank period, the clock signal lines do not output the clock signals, and the data lines do not output valid data signals. The vertical blank period should not be too long to prevent affecting an effective duration. After the vertical blank period, in the subsequent ½ frame, the data signals are converted to the second polarity. The clock signal lines CK2, CK4, CK6, CK8, CK10, and CK12 sequentially output the clock signals, so that the scan signals G2, G4, G6, G8, G10, G12 are sequentially output. After the scan signal G2 turns on a row of the subpixels, the data signals having the second polarity are input to the data lines transmitting the data signals having the first polarity in the previous ½ frame, so as to charge the row of the subpixels.

As shown in FIG. 8B, it is a schematic diagram of polarity distribution of corresponding subpixels driven by the timing diagram shown in FIG. 8A. It can be known from FIG. 8B, when the first scan line group includes odd scan lines, and the second scan line group includes even scan lines, polarities of every data line D are opposite in the previous frame and the subsequent ½ frame. When the polarities of the data signals input from two adjacent data lines D are opposite, a plurality of positive-polarity subpixels or a plurality of negative-polarity subpixels are concentrated on a same diagonal line, which causes problem of a diagonal line during display. Two adjacent subpixels in the same row are respectively the high gray level and the low gray level, the polarities of the high gray level subpixels are same (all positive polarity), and the polarities of the low gray level subpixels are same (all negative polarity), which cause the problem of the horizontal crosstalk.

### First Embodiment

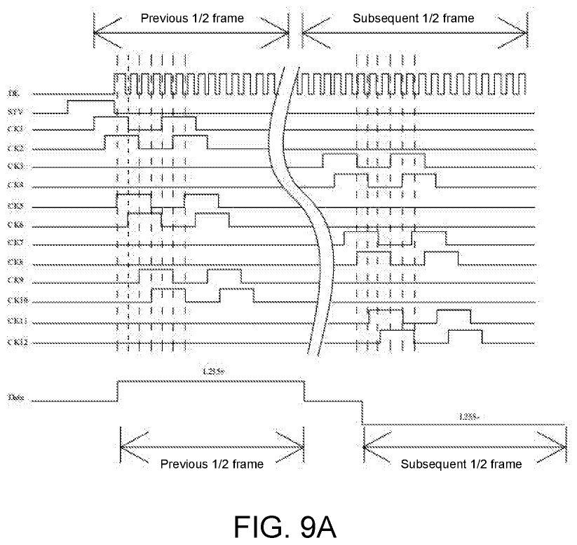

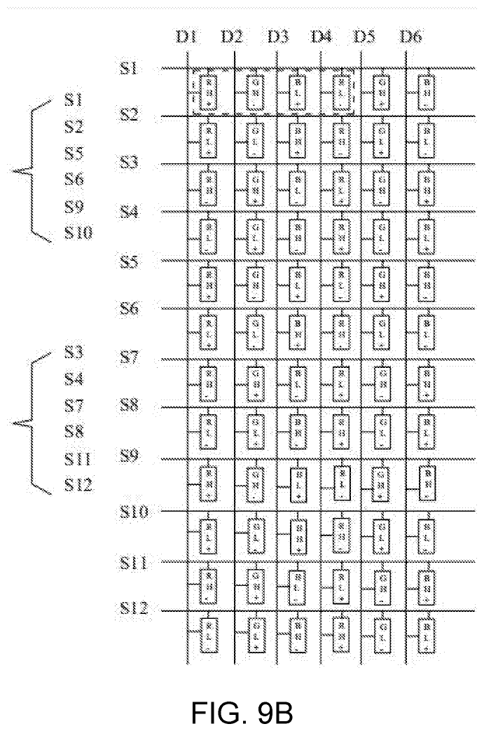

As shown in FIG. 9A, it is a first timing diagram of the driving method of an embodiment of the present application. In this embodiment, the first scan line group includes a (4n−3)th scan line and a (4n−2)th scan line such as the scan lines S1, S2, S5, S6, S9, and S10, and the second scan line group includes a (4n−1)th scan line and a 4nth scan line such as S3, S4, S7, S8, S11, and S12, where n is an integer greater than or equal to 1 and less than or equal to m, and m is an integer greater than or equal to 1. A sum of a total number of the scan lines of the first scan line group and the second scan line group is 4m. In the previous ½ frame, the clock lines CK1, CK2, CK5, CK6, CK9, and CK10 sequentially output the clock signals to sequentially output the scan signals G1, G2, G5, G6, G9, and G10, and each data line transmits the data signals with a constant polarity at this stage. A process during the vertical blank period is same as the comparative embodiment, and is not described in detail herein. In the subsequent ½ frame, the data signals are converted to the second polarity, the clock lines CK3, CK4, CK7, CK8, CK11, and CK12 sequentially output the clock signals to sequentially output the scan signals G3, G4, G7, G8, G11, and G12. While the present application achieves the 2-line inversion, the problem of high power consumption of the source driving unit in the traditional 2-line inversion is prevented. In the previous ½ frame and the subsequent ½ frame, two adjacent subpixels in four adjacent subpixels in the same row are input the data signals corresponding to the high gray levels, and another two adjacent subpixels are input the data signals corresponding to the low gray levels. The gray level values corresponding to the high gray levels are greater than the gray level values corresponding to the low gray levels. When the polarities of the data signals input from combining two adjacent data lines D are opposite, it is possible to prevent vertical lines and diagonal lines from occurring in the traditional structure with a column inversion. Also, the problem of the diagonal lines occurring in a driving of the first scan line group including the odd scan lines and the second scan line group including the even scan lines in combination with adjacent data lines D is prevented, so as to prevent the problem of the horizontal crosstalk.

In this embodiment, in the previous ½ frame and the subsequent ½ frame, two adjacent subpixels in the same column are used to respectively input the data signals corresponding to the high gray levels and the data signals corresponding to the low gray levels.

As shown in FIG. 9B, it is a schematic diagram of polarity distribution of corresponding subpixels driven by the display device of an embodiment of the present application using the first timing diagram shown in FIG. 9A. In the previous ½ frame, after sequentially scanning the first scan line S1 and the second scan line S2, the data lines D1, D3, and D5 input the data signals having a positive polarity, and the data lines D2, D4, and D6 input the data signals having a negative polarity. In the subsequent ½ frame, after sequentially scanning the third scan line S3 and the fourth scan line S4, the data signals input from the data lines D1, D3, and D5 are converted from the positive polarity to the negative polarity, and the data signals input from the data lines D2, D4, and D6 are converted from the negative polarity to the positive polarity. After scanning the scan lines in the first scan line group and the second scan line group, all the subpixels are charged, polarities of the subpixels in the same column are “++−−” or “−−++”, which are repeated as a repeating unit, while polarities of two adjacent subpixels in the same row are opposite, and no positive-polarity subpixels or negative-polarity subpixels are distributed on a same vertical line or a diagonal line. This prevents the problem of the vertical lines or the diagonal lines during display. Also, two adjacent subpixels in four adjacent subpixels in the same row are H(+) and H(−), and another two adjacent subpixels are L(+) and L(−). The voltage difference of the high gray level subpixels offsets the voltage difference of the low gray level subpixels generated by the coupling effect due to the pixel electrodes and the data lines adjacent to the pixel electrodes and not connected thereto, which prevents the problem of the horizontal crosstalk.

### Second Embodiment

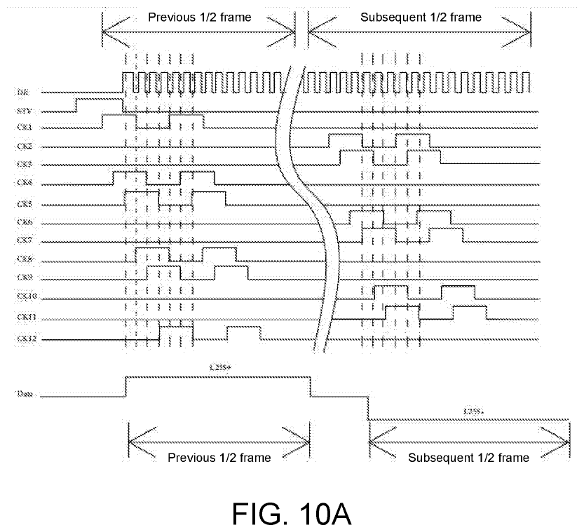

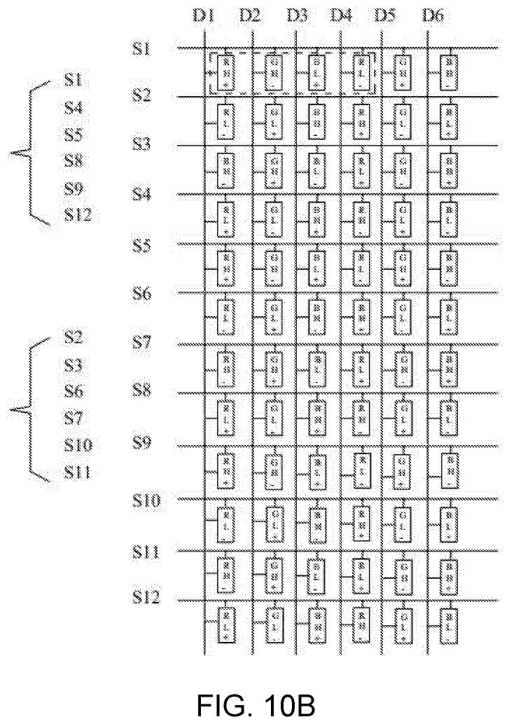

As shown in FIG. 10A, it is a second timing diagram of the driving method of an embodiment of the present application. In this embodiment, the first scan line group includes a (12n−11)th scan line, a (12n−8)th scan line, a (12n−7)th scan line, a (12n−4)th scan line, a (12n−3)th scan line, and a 12nth scan line such as the scan lines S1, S4, S5, S8, S9, and S12; and the second scan line group includes a (12n−10)th scan line, a (12n−9)th scan line, a (12n−6)th scan line, a (12n−5)th scan line, a (12n−2)th scan line, and a (12n−1)th scan line such as S2, S3, S6, S7, S10, and S11, where n is an integer greater than or equal to 1 and less than or equal to m, and m is an integer greater than or equal to 1. A sum of a total number of the scan lines of the first scan line group and the second scan line group is 12m. In the previous ½ frame, the clock lines CK1, CK4, CK5, CK8, CK9, and CK12 sequentially output the clock signals to sequentially output the scan signals G1, G4, G5, G8, G9, and G12, and each data line transmits the data signals with a constant polarity at this stage. In the subsequent ½ frame, the data signals are converted to the second polarity, the clock lines CK2, CK3, CK6, CK7, CK10, and CK11 sequentially output the clock signals to sequentially output the scan signals G2, G3, G6, G7, G10, and G11. While the present application achieves the 1+2-line inversion, the problem of high power consumption of the source driving unit in the traditional 1+2-line inversion is prevented. In the previous ½ frame and the subsequent ½ frame, two adjacent subpixels in four adjacent subpixels in the same row are input the data signals corresponding to the high gray levels, and another two adjacent subpixels are input the data signals corresponding to the low gray levels. The gray level values corresponding to the high gray levels are greater than the gray level values corresponding to the low gray levels. In the previous ½ frame and the subsequent ½ frame, the polarities of the data signals input from two adjacent data lines D are opposite, which can prevent vertical lines and diagonal lines from occurring in the traditional structure with a column inversion and prevent the problem of the horizontal crosstalk.

As shown in FIG. 10B, it is a schematic diagram of polarity distribution of corresponding subpixels driven by the display device of an embodiment of the present application using the first timing diagram shown in FIG. 10A. It can be known from FIGS. 10A and 10B, in the previous ½ frame, after sequentially scanning the first scan line S1, the data lines D1, D3, and D5 input the data signals having the positive polarity, and the data lines D2, D4, and D6 input the data signals having the negative polarity. In the subsequent ½ frame, after sequentially scanning the third scan line S3 and the third scan line S3, the data signals input from the data lines D1, D3, and D5 are converted from the positive polarity to the negative polarity, and the data signals input from the data lines D2, D4, and D6 are converted from the negative polarity to the positive polarity. After scanning the scan lines in the first scan line group and the second scan line group, all the subpixels are charged, a distribution of the positive-polarity subpixels and the negative-polarity subpixels is dispersed, and there is no positive-polarity subpixels or negative-polarity subpixels distributed on the same vertical line or the diagonal line, which prevents the problem of the vertical lines or the diagonal lines during display. Also, two adjacent subpixels in four adjacent subpixels in the same row are H(+) and H(−), and another two adjacent subpixels are L(+) and L(−). The voltage difference of the high gray level subpixels offsets the voltage difference of the low gray level subpixels generated by the coupling effect due to the pixel electrodes and the data lines adjacent to the pixel electrodes and not connected thereto, which prevents the problem of the horizontal crosstalk.

In addition, the above scan lines are divided into two groups, and a driving effect of multiple line inversions can be obtained with a common inversion method.

It needs to be explained that the timing diagrams of the data signals in FIGS. 8A, 9A, and 10A represent timing diagrams of the data signals output from an output channel of the source driving unit. The polarities of the data signals transmitted by two adjacent data lines can be same or different, and the polarities of the data signals transmitted by the same data line in the previous ½ frame and the subsequent ½ frame are opposite, so the data signals output from the same output channel only needs to be inverted once in a period of one frame.

The description of the above embodiments is only for helping to understand technical solutions and core ideas of the present application; persons of ordinary skill in the art should understand that they may still make modifications to the technical solutions described in the above embodiments or make equivalent replacements to some or all technical features thereof, without departing from the scope of the technical solutions of the embodiments of the present application.

What is claimed is:

1. A driving method of a display device;
wherein the display device comprises a plurality of scan lines for transmitting scan signals, a plurality of data lines for transmitting data signals, a gate driving unit, a source driving unit, and a plurality of subpixels arranged in an array;
wherein the plurality of subpixels in each row are connected to a same one of the scan lines, and the plurality of subpixels in each column are connected to a same one of the data lines;
wherein the plurality of scan lines comprise a first scan line group and a second scan line group, and each of the first scan line group and the second scan line group comprises at least two of the scan lines;
wherein the driving method comprises the steps of:
in a previous ½ frame, the gate driving unit inputting the scan signals to the plurality of scan lines in the first scan line group, and the source driving unit inputting the data signals having a first polarity to the plurality of data lines; and
in a subsequent ½ frame, the gate driving unit inputting the scan signals to the plurality of scan lines in the second scan line group, and the source driving unit inputting the data signals having a second polarity to the plurality of data lines transmitting the data signals having the first polarity in the previous ½ frame;
wherein the first polarity is opposite to the second polarity;
wherein in the previous ½ frame and the subsequent ½ frame, polarities of the data signals input from adjacent two of the data lines are opposite; and
wherein two adjacent subpixels in four adjacent subpixels in a same row are input the data signals corresponding to high gray levels, another two adjacent subpixels are input the data signals corresponding to low gray levels, and gray level values corresponding to the high gray levels are greater than gray level values corresponding to the low gray levels;
wherein the first scan line group comprises a (4n−3)th scan line and a (4n−2)th scan line, and the second scan line group comprises a (4n−1)th scan line and a 4nth scan line, where n is an integer greater than or equal to 1 and less than or equal to m, m is an integer greater than or equal to 1, and a sum of a total number of the scan lines of the first scan line group and the second scan line group is 4m; or
wherein the first scan line group comprises a (12n−11)th scan line, a (12n−8)th scan line, a (12n−7)th scan line, a (12n−4)th scan line, a (12n−3)th scan line, and a 12nth scan line, and the second scan line group comprises a (12n−10)th scan line, a (12n−9)th scan line, a (12n−6)th scan line, a (12n−5)th scan line, a (12n−2)th scan line, and a (12n−1)th scan line, where n is an integer greater than or equal to 1 and less than or equal to m, m is an integer greater than or equal to 1, and a sum of a total number of the scan lines of the first scan line group and the second scan line group is 12m.

2. The driving method of the display device according to claim 1, wherein the driving method further comprises the step of:
in the previous ½ frame and the subsequent ½ frame, respectively inputting the data signals corresponding to the high gray levels and the data signals corresponding to the low gray levels to two adjacent subpixels in a same column.

3. The driving method of the display device according to claim 1, wherein the plurality of subpixels in each row comprise red subpixels, green subpixels, and blue subpixels, which are sequentially and repeatedly disposed; and
the plurality of subpixels in each column comprise one of the red subpixels, the green subpixels, or the blue subpixels.

4. The driving method of the display device according to claim 1, wherein a vertical blank period is provided between the previous ½ frame and the subsequent ½ frame.

5. The driving method of the display device according to claim 1, wherein the display device further comprises a timing controller, and the driving method further comprises the steps of:
the timing controller outputting clock signals to the gate driving unit;
the gate driving unit outputting the scan signals to the first scan line group in the previous ½ frame according to the clock signals and outputting the scan signals to the second scan line group in the subsequent ½ frame;
the timing controller outputting polarity inversion control signals to the source driving unit; and
the source driving unit inverting the data signals having the first polarity to the data signals having the second polarity between the previous ½ frame and the subsequent ½ frame according to the polarity inversion control signals.

6. The driving method of the display device according to claim 1, wherein the first polarity is positive, and the second polarity is negative.

7. A display device, comprising a plurality of scan lines, a plurality of data lines, a gate driving unit, a source driving unit, and a plurality of subpixels arranged in an array;
wherein the plurality of subpixels in each row are connected to a same one of the scan lines, and the plurality of subpixels in each column are connected to a same one of the data lines;
wherein the plurality of scan lines comprise a first scan line group and a second scan line group, and each of the first scan line group and the second scan line group comprises at least two of the scan lines;
wherein the gate driving unit is used to input scan signals to the plurality of scan lines in the first scan line group in a previous ½ frame and input the scan signals to the plurality of scan lines in the second scan line group in a subsequent ½ frame;
wherein the source driving unit is used to input data signals having a first polarity to the plurality of data lines in the previous ½ frame and input data signals having a second polarity to the plurality of data lines transmitting the data signals having the first polarity in the previous ½ frame in the subsequent ½ frame, and the first polarity is opposite to the second polarity;
wherein in the previous ½ frame and the subsequent ½ frame, two adjacent data lines are used to respectively input the data signals having opposite polarities;
wherein in the previous ½ frame and the subsequent ½ frame, two adjacent subpixels in four adjacent subpixels in a same row are used to input the data signals corresponding to high gray levels, another two adjacent subpixels are used to input the data signals corresponding to low gray levels, and gray level values corresponding to the high gray levels are greater than gray level values corresponding to the low gray levels;
wherein the first scan line group comprises a (4n−3)th scan line and a (4n−2)th scan line, and the second scan line group comprises a (4n−1)th scan line and a 4nth scan line, where n is an integer greater than or equal to 1 and less than or equal to m, m is an integer greater than or equal to 1, and a sum of a total number of the scan lines of the first scan line group and the second scan line group is 4m; or
wherein the first scan line group comprises a (12n−11)th scan line, a (12n−8)th scan line, a (12n−7)th scan line, a (12n−4)th scan line, a (12n−3)th scan line, and a 12nth scan line, and the second scan line group comprises a (12n−10)th scan line, a (12n−9)th scan line, a (12n−6)th scan line, a (12n−5)th scan line, a (12n−2)th scan line, and a (12n−1)th scan line, where n is an integer greater than or equal to 1 and less than or equal to m, m is an integer greater than or equal to 1, and a sum of a total number of the scan lines of the first scan line group and the second scan line group is 12m.

8. The display device according to claim 7, wherein in the previous ½ frame and the subsequent ½ frame, two adjacent subpixels in a same column are used to respectively input the data signals corresponding to the high gray levels and the data signals corresponding to the low gray levels.

9. The display device according to claim 7, wherein the plurality of subpixels in each row comprise red subpixels, green subpixels, and blue subpixels, which are sequentially and repeatedly disposed; and
the plurality of subpixels in each column comprise one of the red subpixels, the green subpixels, or the blue subpixels.

10. The display device according to claim 7, further comprising a timing controller;
wherein the timing controller is used to output clock signals to the gate driving unit and output polarity inversion control signals to the source driving unit;
wherein the gate driving unit is used to output the scan signals to the first scan line group in the previous ½ frame according to the clock signals and output the scan signals to the second scan line group in the subsequent ½ frame; and
wherein the source driving unit is used to invert the data signals having the first polarity to the data signals having the second polarity between the previous ½ frame and the subsequent ½ frame according to the polarity inversion control signals.

11. The display device according to claim 7, wherein the first polarity is positive, and the second polarity is negative.
